(19) United States
(12) Patent Application Publication
(10) Pub. No.: US 2024/0113560 A1
(43) Pub. Date: Apr. 4, 2024

(54) NONCONTACT POWER SUPPLY DEVICE

(71) Applicant: TOYOTA JIDOSHA KABUSHIKI KAISHA, Aichi-ken (JP)

(72) Inventors: Osamu YAMASHITA, Toyota-shi (JP); Naoki IWATA, Kasugai-shi (JP); Shinjiro SAIGUSA, Toyota-shi (JP); Sungmin CHO, Susono-shi (JP); Katsuya KOBAYASHI, Okazaki-shi (JP); Toshiya HASHIMOTO, Miyoshi-shi (JP)

(21) Appl. No.: 18/457,341

(22) Filed: Aug. 29, 2023

(30) Foreign Application Priority Data
Sep. 29, 2022 (JP) 2022-156942

(51) Int. Cl. H02J 50/00; H02J 50/12; H02J 50/40

(52) U.S. Cl. CPC H02J 50/005; H02J 50/12; H02J 50/402

(57) ABSTRACT

A noncontact power supply device is comprised of a plurality of coil units each having a coil for transmitting power to an object for receiving power by noncontact. Furthermore, the coil units are joined together by a bonding agent having rubbery elasticity.

### FIELD

The present disclosure relates to a noncontact power supply device.

### BACKGROUND

Japanese Unexamined Patent Publication No. 11-95922 discloses a mouse pad with a built-in power transmission coil for transmitting power supplied from a power source to a cordless mouse by noncontact.

### SUMMARY

It may be considered to set a portable power supply mat (noncontact power supply device) at, for example, an event site, evacuation site, or other location where usually noncontact power supply is not possible and to supply power by noncontact at that location. If using a power supply mat to supply power by noncontact to a vehicle or other heavy object, the power supply mat will be subjected to a large load. For this reason, if the power supply mat has no flexibility, for example, if setting the power supply mat at a road surface which is not flat, but has holes or bumps, when the heavy object rides up over the power supply mat, the mat cannot flex to match with the holes or bumps of the road surface. Due to the load of the heavy object, the power supply mat is liable to deteriorate or break.

The present disclosure was made focusing on such a problem and has as its object to secure flexibility of the noncontact power supply device.

To solve the above problem, the noncontact power supply device according to one aspect of the present disclosure is provided with a plurality of coil units each having a coil for transmitting power to an object for receiving power by noncontact, the coil units joined together by a bonding agent having rubbery elasticity.

According to this aspect of the present disclosure, the bonding agent having rubbery elasticity can stretch and contract enabling the power supply mat to bend between the coil units, so the flexibility of the power supply mat can be secured.

### BRIEF DESCRIPTION OF DRAWINGS

FIG. 1 is a schematic perspective view of a power supply mat according to one embodiment of the present disclosure.

FIG. 2 is a schematic cross-sectional view of a power supply mat along the line II-II of FIG. 1.

FIG. 3 is a schematic cross-sectional view of a power supply coil unit along the III-III of FIG. 2.

### DESCRIPTION OF EMBODIMENTS

Below, an embodiment will be explained in detail with reference to the drawings. Note that, in the following explanation, similar component elements will be assigned the same reference notations.

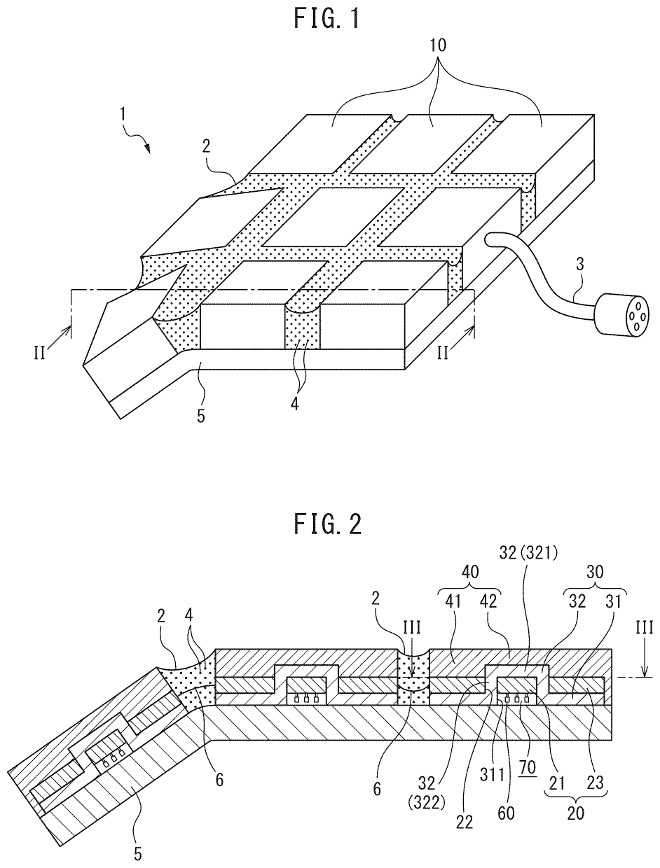

FIG. 1 is a schematic perspective view of a power supply mat 1 according to an embodiment of the present disclosure.

The power supply mat 1 according to the present embodiment has a plurality of power transmission coil units 10 joined by silicone rubber or another bonding agent 2 having a property giving rubbery elasticity after curing. For example, it is set at an event site, evacuation site, or other location where usually noncontact power supply is not possible and supplies power by noncontact to an object for receiving power used at that location. The object for receiving power is not particularly limited in type. It may be a vehicle, drone, or other moving object or may be a communication device, household electric appliance, etc.

The power supply mat 1 is configured to be able to be connected through a power cord 3 to an external AC power source or other power source. Power supplied from the power source is supplied to the power transmission coil units 10 inside of the power supply mat 1.

The power supply mat 1 is envisioned for use in various locations, so greater freedom of installation is sought. Further, to raise the freedom of installation of the power supply mat 1 (that is, to enable the power supply mat 1 to be set on an uneven road surface or a wall surface etc.), it is desirable to give the power supply mat 1 a certain degree of flexibility (pliability) to enable the power supply mat 1 to flex. If the power supply mat 1 does not have flexibility, for example, if setting the power supply mat 1 on an uneven road surface with holes and bumps (for example, an unpaved road surface, a wavy road surface, a road surface made bumpy by rocks, etc.), when a vehicle or other heavy object rides up over the power supply mat 1, the mat cannot flex to match with the holes or bumps on the road surface. Due to the load of the heavy object, the power transmission coil units 10 and in turn the power supply mat 1 are liable to break.

Therefore, in the present embodiment, the power transmission coil units 10 are joined with each other by a bonding agent 2 having the property of rubbery elasticity after curing. Due to this, the bonding agent 2 can stretch and contract enabling the power supply mat 1 to flex between the power transmission coil units 10, so the flexibility of the power supply mat 1 can be raised. For this reason, even if a vehicle or other heavy object rides up over the power supply mat 1, it is possible to make the power supply mat 1 flex to match with the holes or bumps on the road surface and in turn keep the power supply mat 1 from breaking.

Note that in the present embodiment, soft magnetic powder 4 is mixed together with the bonding agent 2 for bonding the power transmission coil units 10 together. Due to this, compared to when not mixing together soft magnetic powder 4 with the bonding agent 2, the magnetic lines of force can easily pass through the inside of the bonding agent 2 and the leakage magnetic flux at the time of noncontact power supply can be reduced, so the power transmission efficiency can be improved.

The elasticity of the bonding agent 2 basically falls the higher the ratio of the soft magnetic powder 4 included in the bonding agent 2 (below, referred to as the “soft magnetic ratio”). For this reason, the soft magnetic ratio is preferably suitably changed in accordance with the performance sought from the power supply mat 1. If stressing the flexibility of the power supply mat 1, it is sufficient to lower the soft magnetic ratio (for example, to 10 vol %). If stressing the power transmission efficiency of the power supply mat 1, it is sufficient to raise the soft magnetic ratio (for example, 50 vol %).

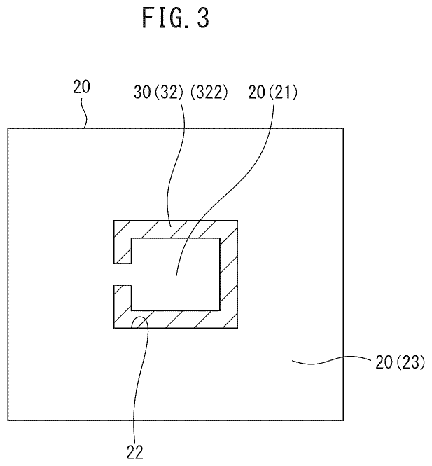

FIG. 2 is a schematic cross-sectional view of a power supply mat along the line II-II of FIG. 1. FIG. 3 is a schematic cross-sectional view of a power supply coil unit 10 along the III-III of FIG. 2.

The power transmission coil units 10 are made thin flat shapes enabling a vehicle to easily ride up over them. For example, as shown in FIG. 2 and FIG. 3, each is provided with a printed coil board 20, a core 30, and a spacer 40. Note that the configuration of the power transmission coil units 10 explained below is just one example. The configuration is not particularly limited so long as one enabling power supplied from a power source to be transmitted by noncontact to an object for receiving power.

The printed coil board 20 is for example a hard printed circuit board on the front surface etc. of which a power transmission coil comprised of a conductor pattern (not shown) is formed. At the back surface side of the center part of the printed coil board 20, for example capacitors 6 and other electronic components are mounted by soldering etc. The power transmission coil formed at the printed coil board 20 forms a resonance circuit together with the capacitors 60 mounted at the printed coil board 20 and transmits power by noncontact to the object for receiving power arranged on the power transmission coil unit 10 through magnetic resonance coupling (magnetic resonance).

As shown in FIG. 3, at the printed coil board 20, if referring to the region at the center part of the back surface side where the capacitors 60 and other electronic components are mounted as the “component mounting part 21”, the printed coil board 20 is formed with a core engaging hole 22 of a C-shaped groove for receiving (or passing) a projecting part 322 of a top core 32 of a later explained core 30 so as to surround the vicinity of the component mounting part 21. Further, the region 23 at the outside from the core engaging hole 22 (below, referred to as the “coil forming part”) is formed so that the circular or rectangular power transmission coil comprised of the conductor pattern surrounds the vicinity of the core engaging hole 22.

The core 30 is provided with a bottom core 31 and top core 32 configured by ferrite or other magnetic material.

The bottom core 31 is a flat plate shaped member formed with a hole 311 at its center part and is arranged at a back surface side of the printed coil board 20. The hole 311 of the bottom core 31 functions as a component holding space 70 at which the capacitors 60 and other electronic components mounted on the printed coil board 20 are held when an electromagnetic shield 5 etc. are arranged on the back surface of the bottom core 31.

The top core 32 is provided with a flat plate shaped peak part 321 covering the front surface of the component mounting part 21 of the printed coil board 20 and a projecting part 322 projecting out from the peak part 321 downward and engaged with the core engaging hole 22 of the printed coil board 20. In the present embodiment, the back surface of the peak part 321 of the top core 32 abuts against the component mounting part 21 of the printed coil board 20.

The spacer 40 is a plastic member for flattening the front surface of the power transmission coil units 10 and protecting the printed coil board 20 and core 30 from a load applied to the power transmission coil units 10. The spacer 40 according to the present embodiment is provided with a thick wall part 41 arranged at the coil forming part 23 of the printed coil board 20 and bonded to its front surface and a thin wall part 42 positioned at a location facing the component mounting part 21 of the printed coil board 20 when arranging the thick wall part 41 at the coil forming part 23.

As shown in FIG. 1 and FIG. 2, at the back surface of the power supply mat 1, an electromagnetic shield 5 is arranged over the entire surface so as to abut against the back surfaces of the bottom cores 31 of the power transmission coil units 10. The electromagnetic shield 5 is a plate shaped member having elasticity comprised of silicone rubber or other rubber member to which a powder of a metal with high conductivity (for example, aluminum flakes) is mixed and decreases the leakage magnetic flux to the back side of the power supply mat 1.

Further, as shown in FIG. 2, the adjoining power transmission coil units 10 are electrically connected by electrical wiring 6 covered by the bonding agent 2. In the present embodiment, as shown in FIG. 1, one of the plurality of power transmission coil units 10 forming the power supply mat 1 is electrically connected to the power source through a power cord. From the power transmission coil unit 10 electrically connected to the power source, power is successively supplied to the adjoining power transmission coil units 10 through electrical wiring 6. In this way, electrical wiring 6 electrically connecting the power transmission coil units 10 together is arranged inside the bonding agent 2 to secure insulation and waterproofness.

The power supply mat 1 (noncontact power supply device) according to the present embodiment explained above is provided with a plurality of power transmission coil units 10 (coil units) each having a coil for transmitting power to an object for receiving power by noncontact, the power transmission coil units 10 joined together by a bonding agent 2 having rubbery elasticity.

Due to this, the bonding agent 2 having rubbery elasticity stretches and contracts and the power supply mat 1 can flex between the power transmission coil units 10, so it is possible to improve the flexibility of the power supply mat 1. For this reason, it is possible to make the power supply mat 1 flex to match with holes and bumps in the road surface even if a vehicle or other heavy object rides up over the power supply mat 1, so the power supply mat 1 can be kept from deteriorating or breaking.

Further, in the present embodiment, soft magnetic powder 4 (soft magnetic member) is mixed together with the bonding agent 2. Due to this, compared to when not mixing together soft magnetic powder 4 with the bonding agent 2, the magnetic lines of force can easily pass through the inside of the bonding agent 2 and the leakage magnetic flux at the time of noncontact power supply can be reduced, so the power transmission efficiency can be improved.

Further, in the present embodiment, electrical wiring 6 for electrically connecting the power transmission coil units 10 with each other are arranged inside of the bonding agent 2, so insulation and waterproofing can be secured.

Above, an embodiment of the present disclosure was explained, but the embodiment only shows one example of application of the present disclosure and is not intended to limit the technical scope of the present disclosure to the specific constitution of the embodiment.

1. A noncontact power supply device comprising a plurality of coil units each having a coil for transmitting power to an object for receiving power by noncontact, the coil units joined together by a bonding agent having rubbery elasticity.

2. The noncontact power supply device according to claim 1, wherein the bonding agent has a soft magnetic member mixed with it.

3. The noncontact power supply device according to claim 1, wherein electrical wiring for electrically connecting the coil units with each other is arranged inside of the bonding agent.
